(19) United States
(12) Patent Application Publication
(10) Pub. No.: US 2015/0207675 A1
(43) Pub. Date: Jul. 23, 2015

(54) Path Control System, Control Apparatus, Edge Node, Path Control Method, And Program

(71) Applicant: NEC CORPORATION, Tokyo (JP)

(72) Inventor: Takeo Hayashi, Tokyo (JP)

(73) Assignee: NEC CORPORATION, Tokyo (JP)

(21) Appl. No.: 14/424,431

(22) PCT Filed: Aug. 27, 2013
(86) PCT No.: PCT/JP2013/005053

§ 371 Date: Feb. 26, 2015

(30) Foreign Application Priority Data
Aug. 28, 2012 (JP) 2012-187867

(51) Int. Cl. H04L 12/24; H04L 12/723; H04L 12/741; H04L 12/703

(52) U.S. Cl. CPC H04L 41/0668; H04L 45/28; H04L 45/507; H04L 45/74

(57) ABSTRACT

A path control system, includes: a forwarding network in which each forwarding node belongs to a group and forwards a packet based on a sub-label corresponding to the group; an edge node that adds a label including a plurality of sub-labels based on information contained in a received packet; and a control apparatus that performs path control of the forwarding network by controlling a combination of sub-labels added by the edge node and by controlling forwarding processing performed based on the sub-labels by the forwarding node(s). When a failure has occurred in a communication path, the control apparatus causes the edge node to change a sub-label corresponding to a failure section of the communication path in which a failure has occurred out of sub-labels added to a packet received after the failure, and causes the forwarding node(s) to forward a packet along a path that does not go through the failure section.

### REFERENCE TO RELATED APPLICATION

The present invention is based upon and claims the benefit of the priority of Japanese Patent Application No. 2012-187867 filed on Aug. 28, 2012, the disclosure of which is incorporated herein in its entirety by reference thereto.

### TECHNICAL FIELD

The present invention relates to a path control system, control apparatus, edge node, path control method, and program, and particularly to a path control system, control apparatus, edge node, path control method, and program including forwarding nodes and a control apparatus that performs centralized control of these forwarding nodes.

### BACKGROUND

When a path failure occurs, an IP network (Internet Protocol Network) uses dynamic routing in which routers exchange path information and a path is recalculated. As protocols used for the information exchanges between the routers, RIP (Routing Information Protocol), OSPF (Open Shortest Path First), and BGP (Border Gateway Protocol) are known.

In the method using the routing protocols above, however, since path information is exchanged and a path is recalculated, it takes time to be able to perform forwarding on an alternate route after avoiding a failed path. As another method for switching to an alternate route at the time of a failure, FRR (Fast ReRoute) in MPLS (Multi-Protocol Label Switching) is known (refer to Non-Patent Literature (NPL) 1). FRR is a technology that switches to an alternate route at the time of a link or node failure on the way in an LSP (Label Switching Path) configured in an MPLS network, calculating and configuring the alternate route in advance.

Further, Non-Patent Literatures 2 and 3 propose a technology called OpenFlow. OpenFlow treats communication as an end-to-end flow, and performs path control, failure recovery, load balancing, and optimization for each flow. An OpenFlow switch specified in Non-Patent Literature 3 comprises a secure channel for communicating with an OpenFlow controller, and operates according to a flow table given an appropriate instruction of addition or rewrite by the OpenFlow controller. In the flow table, a set of matching rules (Match Fields) matching a packet header, flow statistics (Counters), and Instructions defining processing content is defined for each flow (refer to the section of “4.1 Flow Table” in Non-Patent Literature 3).

For instance, upon receiving a packet, the OpenFlow switch searches an entry having a matching rule (refer to “4.3 Match Fields” in Non-Patent Literature 3) that matches the header information of the received packet in the flow table. When an entry matching the received packet is found as a result of the search, the OpenFlow switch updates the flow statistics (Counter) and performs the processing content (packet transmission from a designated port, flooding, discard, etc.) written in the instruction field of the entry on the received packet. Meanwhile, when no entry matching the received packet is found as a result of the search, the OpenFlow switch sends the OpenFlow controller a request to set an entry, i.e., a request (Packet-In message) to determine the processing content for the received packet, via the secure channel. The OpenFlow switch receives a flow entry defining the processing content and updates the flow table. As described, the OpenFlow switch forwards packets using entries stored in the flow table as processing rules.

### CITATION LIST

### Non Patent Literature

[NPL 1]
P. Pan, G. Swallow and A. Atlas, “Fast Reroute Extensions to RSVP-TE for LSP Tunnels,” IETF RFC4090, May 2005, the Internet <URL:

http://www.ietf.org/rfc/rfc4090.txt>.
[NPL 2]
Nick McKeown, et. al., “OpenFlow: Enabling Innovation in Campus Networks,” [online], [searched on May 31, 2012], the Internet <URL: http://www. openflow.org/documents/openflow-wp-latest. pdf>.
[NPL 3]
“OpenFlow Switch Specification” Version 1.1.0 Implemented (Wire Protocol 0x02), [online], [searched on May 31, 2012], the Internet <URL: http://www.openflow.org/documents/openflow-spec-v1.1.0 .pdf>.

### SUMMARY

### Technical Problem

The above Non-Patent Literatures are incorporated herein in their entirety by reference thereto. The following analysis is given by the present invention. The first problem with FRR in MPLS is that it cannot flexibly select an alternate route when a failure occurs in a network. The reason is that FRR realizes an alternate route by switching to an alternate route configured in advance when a failure occurs. Further, the second problem with FRR is an increase in the settings of network equipment. The reason is that it is necessary to perform configurations for performing forwarding using an alternate route when a failure occurs in a network, and in a case where the configuration is performed for each application (label), the number of settings (the number of entries in a LIB (Label Information Base)) increases.

Further, OpenFlow in Non-Patent Literatures 2 and 3 comprises functions of controlling a path and recovering from a failure for each flow, however, since it is necessary to calculate an alternate route, create a flow entry realizing the path, and set it in each OpenFlow switch, a considerable amount of load is imposed. It is possible to calculate an alternate route and set it in each OpenFlow switch in advance, but if an alternate route has to be set for each flow, the number of flow entries held by each OpenFlow switch increases, as in the case of MPLS.

It is an object of the present invention to provide a path control system, control apparatus, edge node, path control method, and program capable of detailed forwarding control using alternate routes without increasing the number of entries set in a forwarding node in a network.

### Solution to Problem

According to a first aspect of the present invention, there is provided a path control system, comprising: a forwarding network in which each forwarding node belongs to a group and forwards a packet based on a sub-label corresponding to the group; at least one edge node that adds a label including a plurality of sub-labels based on information contained in a received packet; and a control apparatus that performs path control of the forwarding network by controlling a combination of sub-labels added by the edge node and by controlling forwarding processing performed based on the sub-labels by the forwarding node(s). When a failure has occurred in a communication path, the control apparatus causes the edge node to change a sub-label corresponding to a failure section of the communication path in which a failure has occurred out of sub-labels added to a packet received after the failure, and causes the forwarding node(s) to forward a packet along a path that does not go through the failure section.

According to a second aspect of the present invention, there is provided a control apparatus. The control apparatus is connected to a forwarding network in which each forwarding node belongs to a group and forwards a packet based on a sub-label corresponding to the group and to at least one edge node that adds a label including a plurality of sub-labels based on information contained in a received packet, and performs path control of the forwarding network by controlling a combination of sub-labels added by the edge node and by controlling forwarding processing performed based on the sub-labels by the forwarding node(s). When a failure has occurred in a communication path, the control apparatus causes the edge node to change a sub-label corresponding to a failure section of the communication path in which the failure has occurred out of sub-labels added to a packet received after the failure, and causes the forwarding node(s) to forward a packet along a path that does not go through the failure section.

According to a third aspect of the present invention, there is provided at least one edge node that adds sub-labels based on an entry that matches a received packet and that is selected, based on a source address and payload content of the received packet, from a path entry group in which priority information, a destination address, and a combination of sub-labels are associated with each other.

According to a fourth aspect of the present invention, there is provided a path control method, in a path control system that comprises a forwarding network in which each forwarding node belongs to a group and forwards a packet based on a sub-label corresponding to the group, at least one edge node that adds a label including a plurality of sub-labels based on information contained in a received packet, and a control apparatus that performs path control of the forwarding network by controlling a combination of sub-labels added by the edge node and controlling forwarding processing performed based on the sub-labels by the forwarding node(s). The path control method comprises: detecting whether or not a failure has occurred in the communication path; when a failure has occurred in the communication path, causing the edge node to change a sub-label corresponding to a failure section of the communication path in which the failure has occurred out of sub-labels added to a packet received after the failure; and causing the forwarding node(s) to forward a packet along a path that does not go through the failure section. The present method is tied to a specific machine, i.e., the control apparatus that controls the forwarding node and the edge node.

According to a fifth aspect of the present invention, there is provided a program for a computer provided in a control apparatus in a path control system that comprises a forwarding network in which each forwarding node belongs to a group and forwards a packet based on a sub-label corresponding to the group, at least one edge node that adds a label including a plurality of sub-labels based on information contained in a received packet, and the control apparatus that performs path control of the forwarding network by controlling a combination of sub-labels added by the edge node and controlling forwarding processing performed based on the sub-labels by the forwarding node(s). The program causes the computer to execute: detecting whether or not a failure has occurred in the communication path; when a failure has occurred in the communication path, causing the edge node to change a sub-label corresponding to a failure section of the communication path in which the failure has occurred out of sub-labels added to a packet received after the failure; and causing the forwarding node(s) to forward a packet along a path that does not go through the failure section. Further, this program can be stored in a computer-readable (non-transient) storage medium. In other words, the present invention can be realized as a computer program product.

### Advantageous Effects of Invention

According to the present invention, it becomes possible to perform detailed forwarding processing using an alternate route without increasing the number of entries set in a forwarding node in a network.

### BRIEF DESCRIPTION OF DRAWINGS

FIG. 1 is a drawing illustrating the configuration of a path control system of an exemplary embodiment of the present disclosure.

FIG. 2 is a drawing for explaining the operation of a path control system of an exemplary embodiment of the present disclosure.

FIG. 3 is a drawing illustrating the configuration of a path control system of a first exemplary embodiment of the present disclosure.

FIG. 4 is a drawing illustrating an edge node of the first exemplary embodiment of the present disclosure.

FIG. 5 is a drawing showing the configuration of a priority table held by the edge node of the first exemplary embodiment of the present disclosure.

FIG. 6 is a drawing showing the configuration of a path table held by the edge node of the first exemplary embodiment of the present disclosure.

FIG. 7 is a drawing showing the configuration of a label added to a packet by the edge node of the first exemplary embodiment of the present disclosure.

FIG. 8 is a drawing showing the configuration of a flow table set in a forwarding node of the first exemplary embodiment of the present disclosure.

FIG. 9 is a flowchart showing the operation of the edge node of the first exemplary embodiment of the present disclosure.

FIG. 10 is a flowchart showing the operation of a control apparatus of the first exemplary embodiment of the present disclosure.

FIG. 11 is a drawing illustrating the configuration of a path control system of a second exemplary embodiment of the present disclosure.

FIG. 12 is a drawing showing the configuration of a path table held by an edge node of the second exemplary embodiment of the present disclosure.

FIG. 13 is a drawing showing the configuration of a label added to a packet by the edge node of the second exemplary embodiment of the present disclosure.

FIG. 14 is a drawing showing the configuration of a flow table set in a forwarding node of the second exemplary embodiment of the present disclosure.

FIG. 15 is a drawing illustrating the configuration of a path control system of a third exemplary embodiment of the present disclosure.

FIG. 16 is a drawing showing the configuration of a priority table held by an edge node of the third exemplary embodiment of the present disclosure.

FIG. 17 is a drawing showing the configuration of a path table held by the edge node of the third exemplary embodiment of the present disclosure.

FIG. 18 is a drawing showing the configuration of a flow table set in a forwarding node of the third exemplary embodiment of the present disclosure.

### DESCRIPTION OF EMBODIMENTS

First, a summary of an exemplary embodiment of the present disclosure will be given with reference to the drawings. Note that drawing reference signs used in the summary are given to elements for convenience as examples to facilitate understanding, and are not intended to limit the present disclosure to exemplary embodiments shown in the drawings.

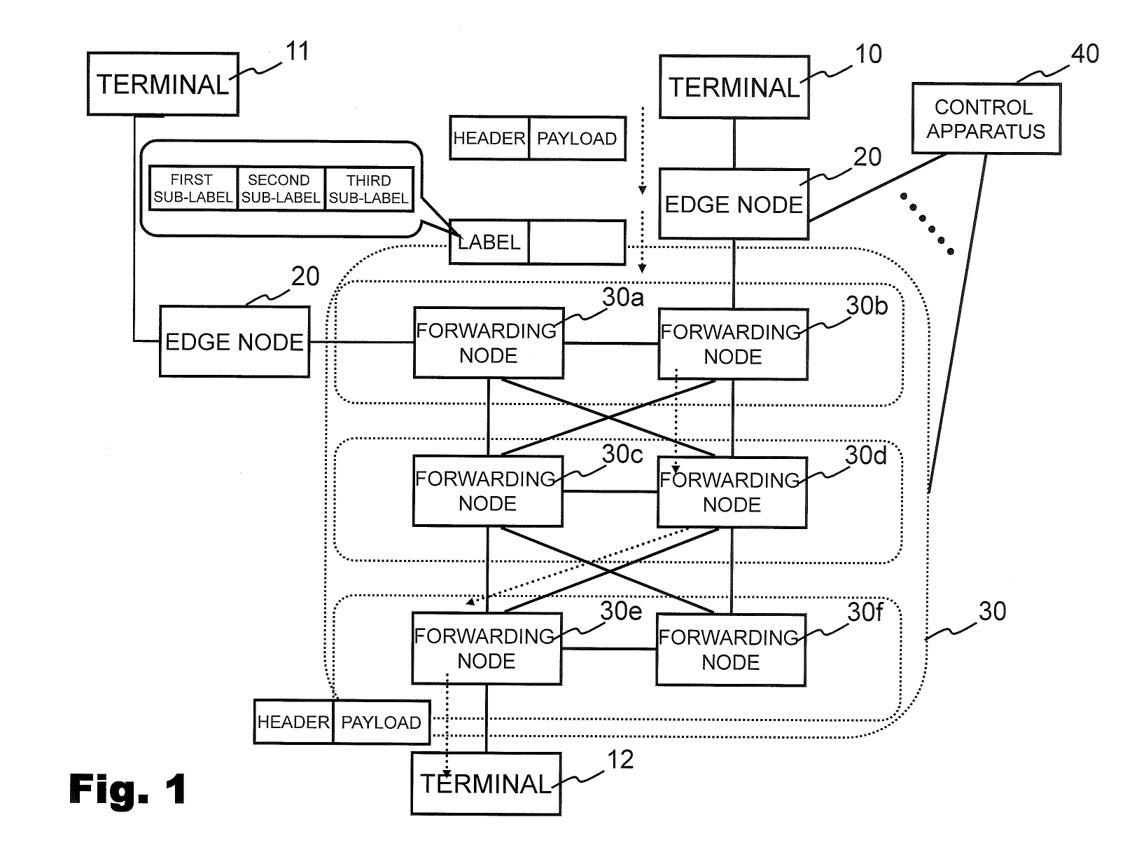

The present disclosure in an exemplary embodiment thereof can be realized by a configuration that includes a forwarding network 30 constituted by a plurality of forwarding nodes 30a to 30f, an edge node(s) 20 that adds a label to a packet flowing through the forwarding network, and a control apparatus 40 that controls the forwarding nodes 30a to 30f and the edge node(s) 20, as shown in FIG. 1.

The forwarding nodes 30a to 30f are divided into several groups by lumping together forwarding nodes in a parallel relationship (alternate relationship) to each other when communication between two points in the network topology is realized. Each of the forwarding nodes 30a to 30f forwards a packet based on a sub-label corresponding to the group where it belongs. For instance, in an example in FIG. 1, three groups of the forwarding nodes 30a and 30b, the forwarding nodes 30c and 30d, and the forwarding nodes 30e and 30f are provided.

The edge node 20 adds a label constituted by a plurality of sub-labels based on packet information received. In the example in FIG. 1, the edge node 20 adds a label constituted by three sub-labels to a packet received from a terminal 10 or 11 according to a label adding rule specified by the control apparatus 40 in advance.

The control apparatus 40 specifies the label adding rule for the received packet to the edge node 20. Further, the control apparatus instructs the forwarding nodes 30a to 30f to perform forwarding processing based on the sub-labels. For instance, the control apparatus 40 instructs the forwarding nodes 30a and 30b, the most upstream group from the terminal 10, to refer to the first sub-label (the sub-label on the left in the speech balloon in FIG. 1) of a received packet and determine a forwarding destination according to the value thereof. Similarly, the forwarding nodes 30a and 30d refer to the second sub-label (the sub-label in the center in the speech balloon in FIG. 1) of the received packet and determine a forwarding destination. Similarly, the forwarding nodes 30e and 30f refer to the third sub-label (the sub-label on the right in the speech balloon in FIG. 1) of the received packet and determine a forwarding destination. As a result, the forwarding nodes 30a to 30f are able to execute packet forwarding to the terminals 10 to 12 and packet forwarding to the terminals 11 and 12 with a single forwarding entry.

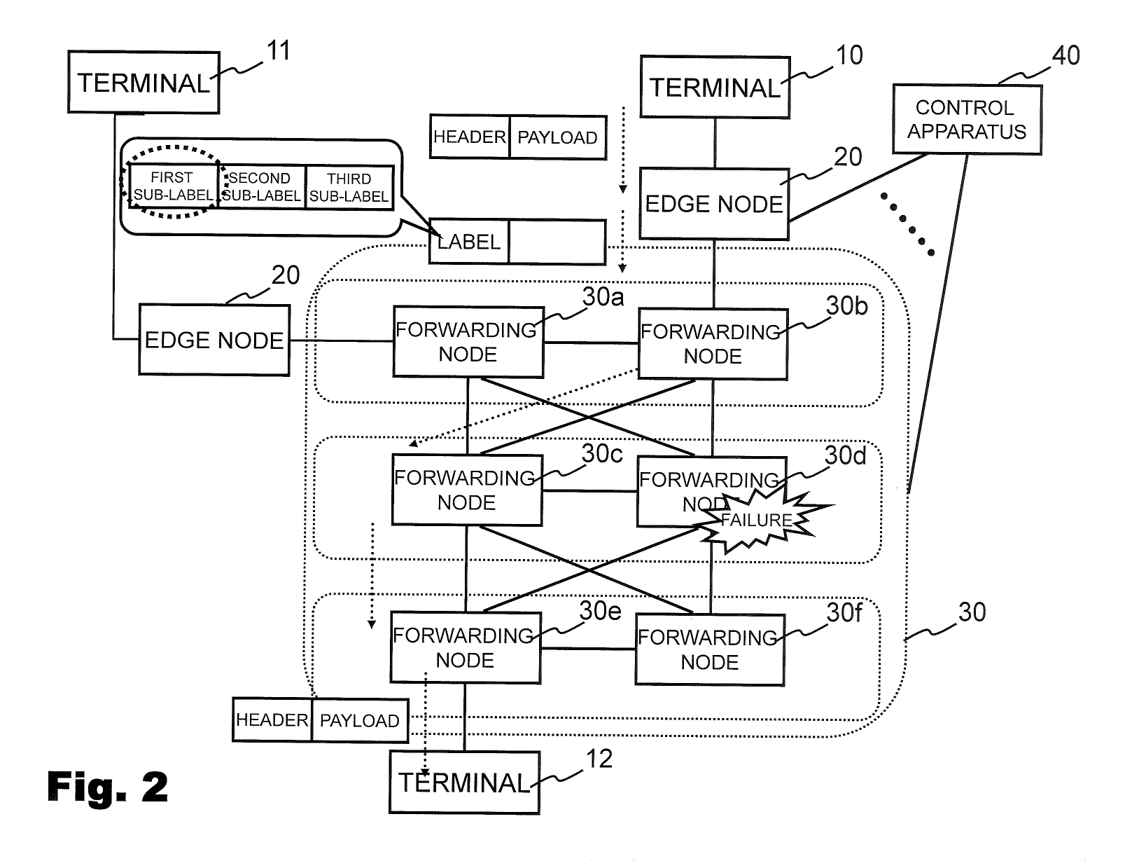

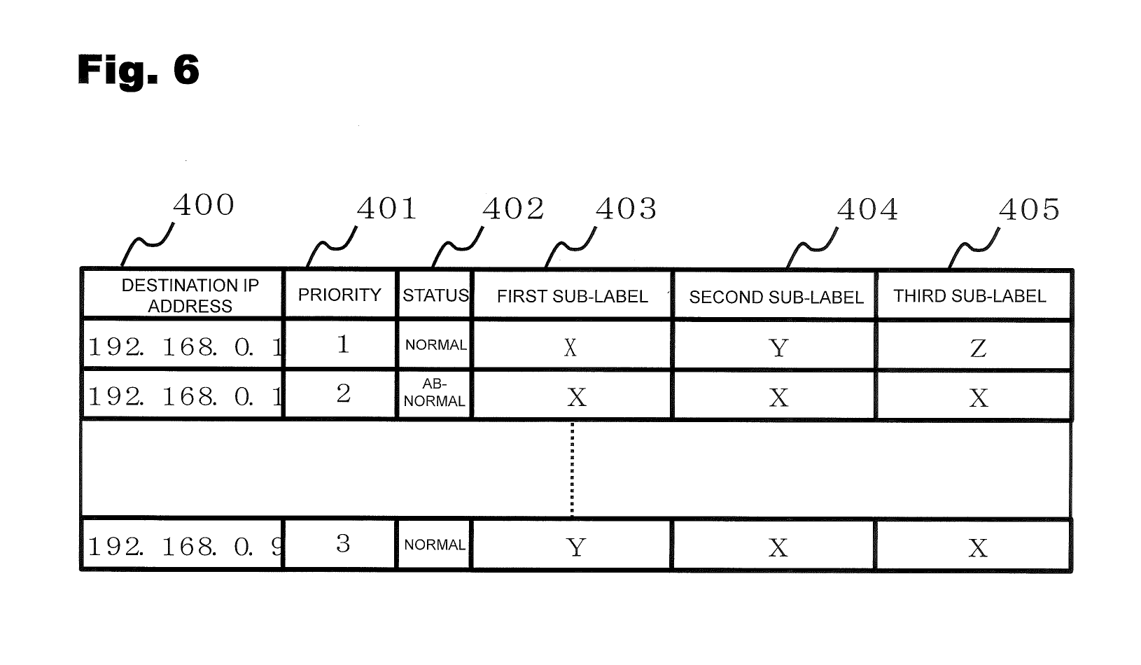

Further, when detecting a failure in a forwarding node on the path, the control apparatus 40 performs the following operation. For instance, when a failure occurs in the forwarding node 30d as shown in FIG. 2, the control apparatus 40 notifies the edge node 20 of the failure in the forwarding node 30d and has the edge node 20 change a value written as the first sub-label (for instance, the edge node 20 updates a path table illustrated in FIG. 6). As a result of the above, packets from the terminals 10 and 11 are forwarded to the terminal 12 via the. forwarding node 30c instead of the forwarding node 30d, as indicated by the arrows in FIG. 2.

As described above, forwarding processing using an alternate route can be achieved without increasing the number of entries set in a forwarding node in a network.

### First Exemplary Embodiment

Next, a first exemplary embodiment of the present disclosure, in which an alternate route is configured in advance, will be described in detail with reference to the drawing.

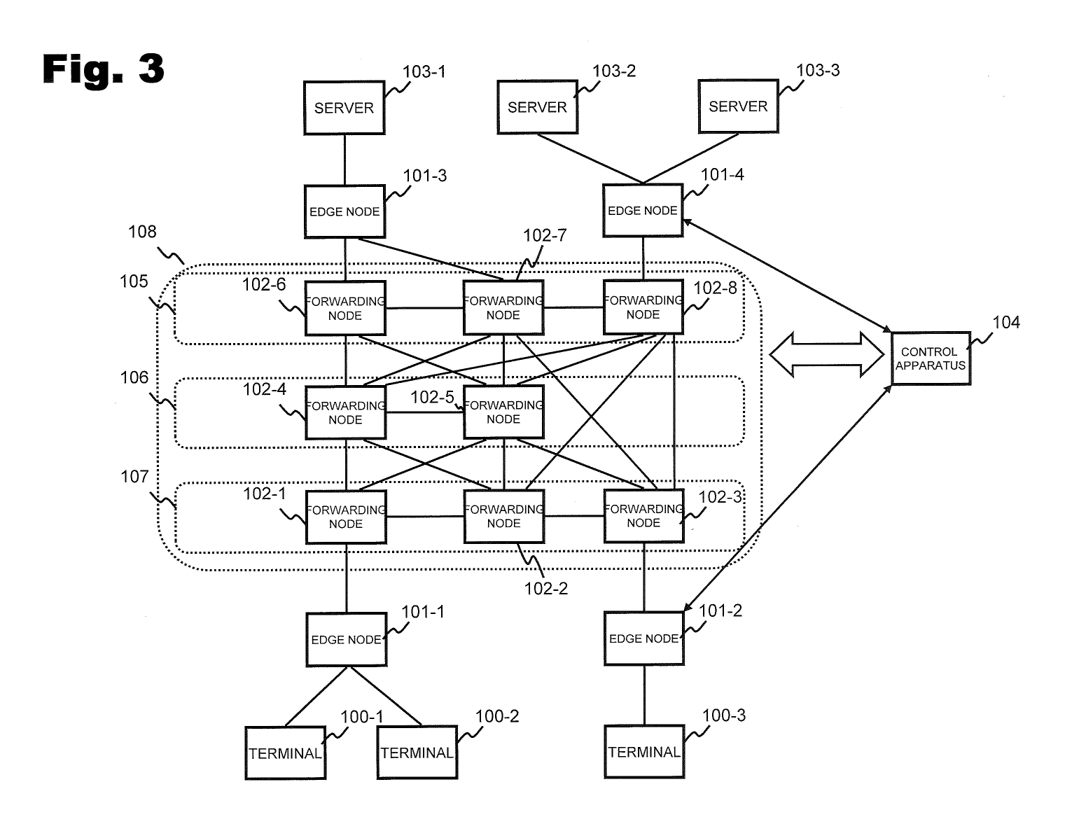

FIG. 3 is a drawing illustrating the configuration of a path control system of the first exemplary embodiment of the present disclosure. FIG. 3 shows a configuration including terminals 100-1 to 100-3, servers 103-1 to 103-3, a forwarding network 108 constituted by forwarding nodes 102-1 to 102-8, edge nodes 101-1 to 101-4 disposed between the forward network 108 and external nodes such as the terminals and the servers, and a control apparatus 104 that monitors and controls the forwarding network 108 and the edge nodes 101-1 to 101-4. Note that the edge nodes 101-1 to 101-4 in the example in FIG. 3 are directly connected to the terminals 100-1 to 100-3 and the servers 103-1 to 103-3, however, a network device such as a switch may exist between the edge nodes and the terminals 100-1 to 100-3 and the server 103-1 to 103-3.

In the description hereinafter, the terminals 100-1 to 100-3, the edge nodes 101-1 to 101-4, the forwarding nodes 102-1 to 102-8, and the servers 103-1 to 103-3 will be referred to as the terminal 100, the edge node 101, the forwarding node 102, and the server 103, respectively, unless there is a need to distinguish them.

The forwarding network 108 is constituted by the forwarding nodes 102-1 to 102-8 capable of controlling forwarding for each flow. It is possible to set a forwarding destination in the forwarding node 102 for each flow by the instruction of the control apparatus 104 and the forwarding node 102 corresponds to the switch conforming to the specifications of Non-Patent Literature 3. The forwarding nodes 102 belong to any one of a first horizontal level 105, a second horizontal level 106, and a third horizontal level 107. A flow means a flow of a sequence of packets defined by a combination of, for instance, a source, source MAC (Media Access Control) address, IP address, and a port number, but the elements are not limited thereto. Further, the forwarding network 108 is divided into three horizontal levels in the present exemplary embodiment, but the configuration of the forwarding network is not limited to this.

The control apparatus 104 operates as a control apparatus that controls the edge nodes 20 (described later) and the forwarding nodes 102. A dedicated channel is provided between the control apparatus 104 and the forwarding nodes 102 so as to send and receive control messages. Further, the OpenFlow protocol in Non-Patent Literature 3 can be used as the protocol for sending/receiving these control messages.

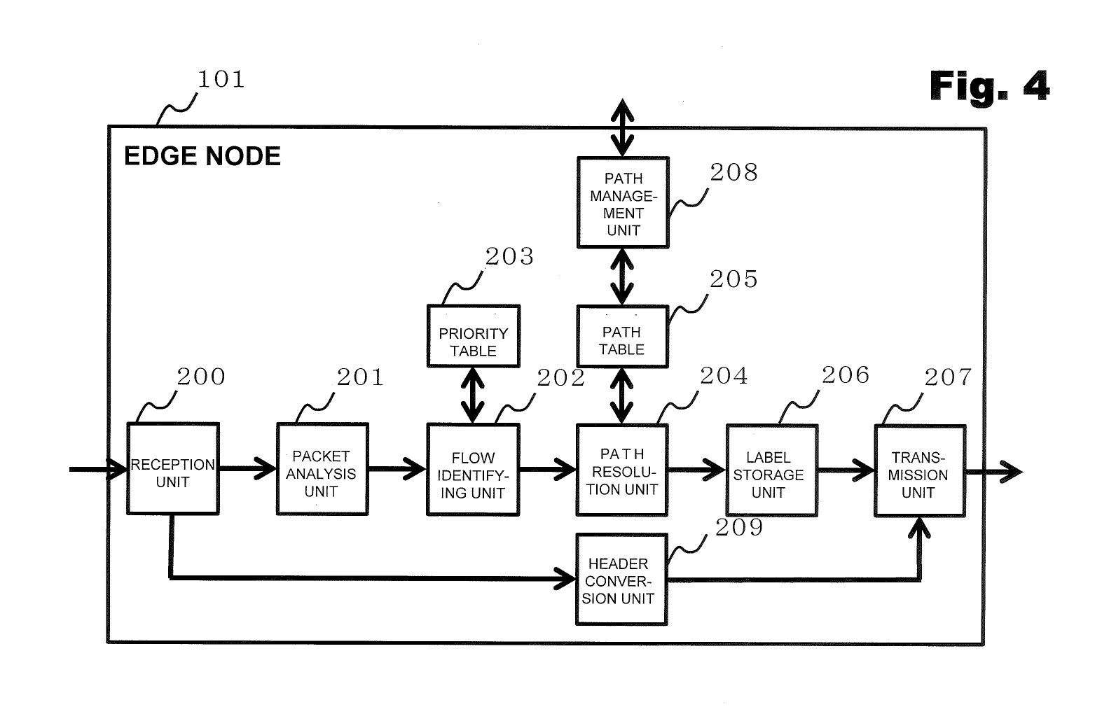

FIG. 4 is a block diagram illustrating a detailed configuration example of the edge node 101 in FIG. 3. With reference to FIG. 4, the edge node 101 is constituted by a reception unit 200, a packet analysis unit 201, a flow identifying unit 202, a priority table 203, a path table 205 that stores path information of the forwarding network 108, a path resolution unit 204 that determines a path by referring to the path table 205, a path management unit 208 that updates the information in the path table 205 according to the instruction of the control apparatus 104, a label storage unit 206, a transmission unit 207, and a header conversion unit 209.

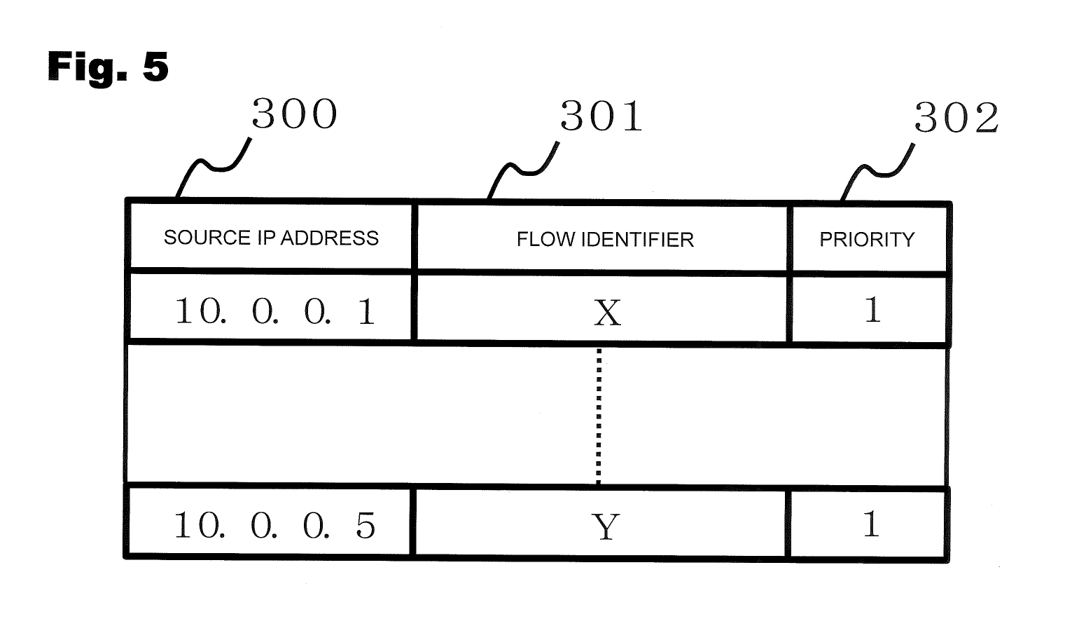

FIG. 5 is a drawing showing a detailed configuration example of the priority table 203 in FIG. 4. The priority table 203 stores entries in which a source IP address 300 for specifying a terminal and user, a flow identifier 301 that specifies a service to be used, and priority 302 are associated with each other. As the flow identifier 301, URLs (Uniform Resource Locator) the in Web service can be used. Needless to say, it is not limited to URLs, and any information specifying an application may be used. Further, the source IP address 300 can be any information that can specify a user or terminal without being limited to IP addresses.

FIG. 6 is a drawing showing a detailed configuration example of the path table 205 in FIG. 4. The path table 205 stores entries in which a destination IP address 400, priority 401, a path status 402 that indicates whether or not a path is available, a first sub-label 403 used by the forwarding nodes 102 belonging to the first horizontal level 105, a second sub-label 404 used by the forwarding nodes 102 belonging to the second horizontal level 106, and a third sub-label 405 used by the forwarding nodes 102 belonging to the third horizontal level 107 are associated with each other. As described later, these entries function as label adding rules for adding a label with a sub-label combination according to the payload content of a packet.

The path resolution unit 204 resolves sub-labels using the destination IP address 400 and the priority 401 as search keys. The path information stored in the path table 205 can have a plurality of entries having the same destination and priority, and for instance, entries are registered in such a manner that top entries get hit first in FIG. 6. In other words, normal forwarding entries are registered in the top rows of the path table 205, and entries for alternate routes at the time of failure are registered below them. By doing so, when the path status 402 of a normal forwarding entry becomes abnormal, an entry for an alternate route can be obtained as a result of a search.

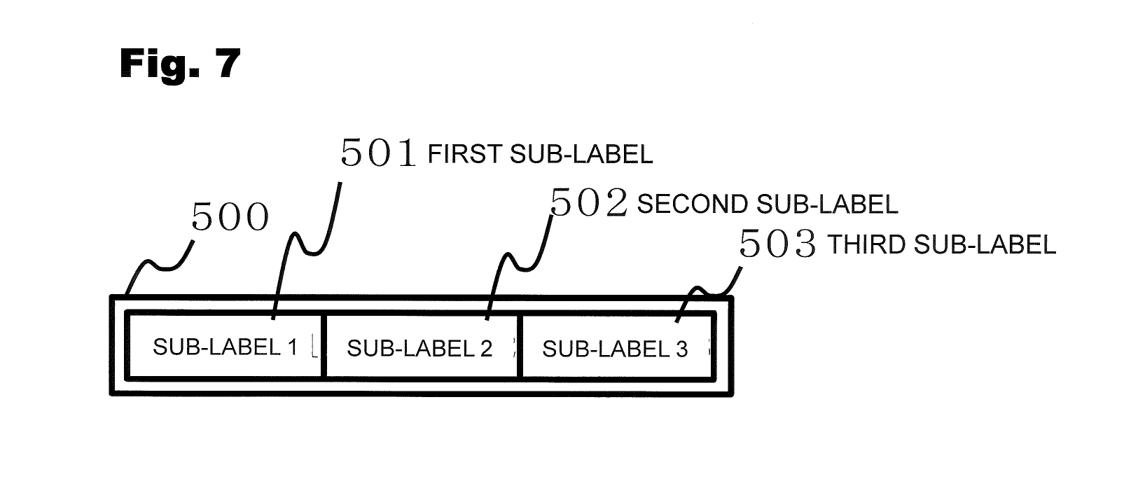

FIG. 7 is a drawing showing a label that the label storage unit 206 stores in a packer header. The label 500 is constituted by a first sub-label 501 used by the forwarding nodes 102 belonging to the first horizontal level 105, a second sub-label 502 used by the forwarding nodes 102 belonging to the second horizontal level 106, and a third sub-label 503 used by the forwarding nodes 102 belonging to the third horizontal level 107.

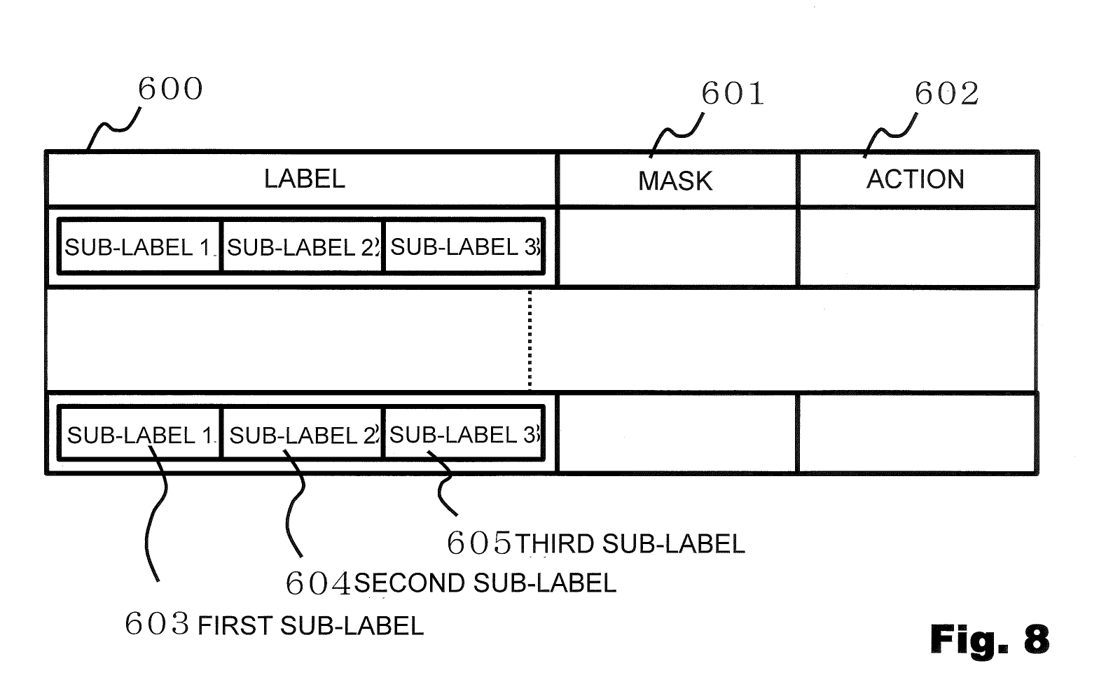

FIG. 8 is a drawing showing a detailed configuration of a flow table for determining the forwarding destination of a packet in the forwarding node 102. The flow table stores entries in which a label 600 stored in a packet header, a mask 601 that indicates which part of the label the level where the forwarding node 102 belongs should refer to, and an action 602 that indicates the operation of the forwarding nodes such as an output port are associated with each other. The action 602 corresponds to instructions to output a packet to a designated port or to rewrite a packet header. For instance, when a packet having a mask indicating reference to the first sub-label 501 and the same sub-label as the first sub-label 501 is received, an entry that sets an action defining processing applied to this packet is set for the forwarding nodes 102 belonging to the first horizontal level 105 (the same for the other forwarding nodes).

Next, the entire operation of the present exemplary embodiment will be described in detail with reference to the drawings. The description of the present exemplary embodiment below describes a path control method in a case where a failure occurs in the forwarding node 102 or a path failure occurs between the forwarding nodes 102 in communication between the terminal 100-1 and the server 103-1 via the forwarding network 108.

Between the terminal 100-1 and the server 103-1, a plurality of paths exist such as a path going through the forwarding nodes 102-1, 102-4, and 102-6 or a path going through the forwarding nodes 102-1, 102-5, and 102-6. In the description below, it is assumed that normal forwarding operations utilize the path going through the forwarding nodes 102-1, 102-5, and 102-6 and an alternate route goes through the forwarding nodes 102-1, 102-4, and 102-6.

The control apparatus 104 configures the flow tables in the forwarding nodes 102 constituting the forwarding network 108 at a predetermined timing such as an initialization or the start of communication. More concretely, the control apparatus 104 registers the entries in which the first to the third sub-labels 603 to 605, the mask 601, and the action 602 are associated with each other according to the horizontal level where the forwarding node 102 belong, as shown in FIG. 8. For instance, the first sub-label 603 and the mask 601 indicating reference to the first sub-label 603 are set in the forwarding node 102-1, and the processing defined in the action 602 field is performed when a packet with a sub-label (the first sub-label) matching these is received. For instance, the action 602 corresponds to outputting from a designated port.

For instance, with a 48-port switch, since all the ports can be expressed with 6-bit information, the first sub-label 603 may be 6-bit information. The control apparatus 104 sets an entry in which the sub-label value of the level where each forwarding node belongs is associated with an output port in the flow table of the forwarding node 102. Further, the control apparatus 104 notifies the edge node 101 of the sub-label information set in the forwarding node 102. The path management unit 208 in the edge node 101 sets path entries having the notified sub-label combinations in the path table 205.

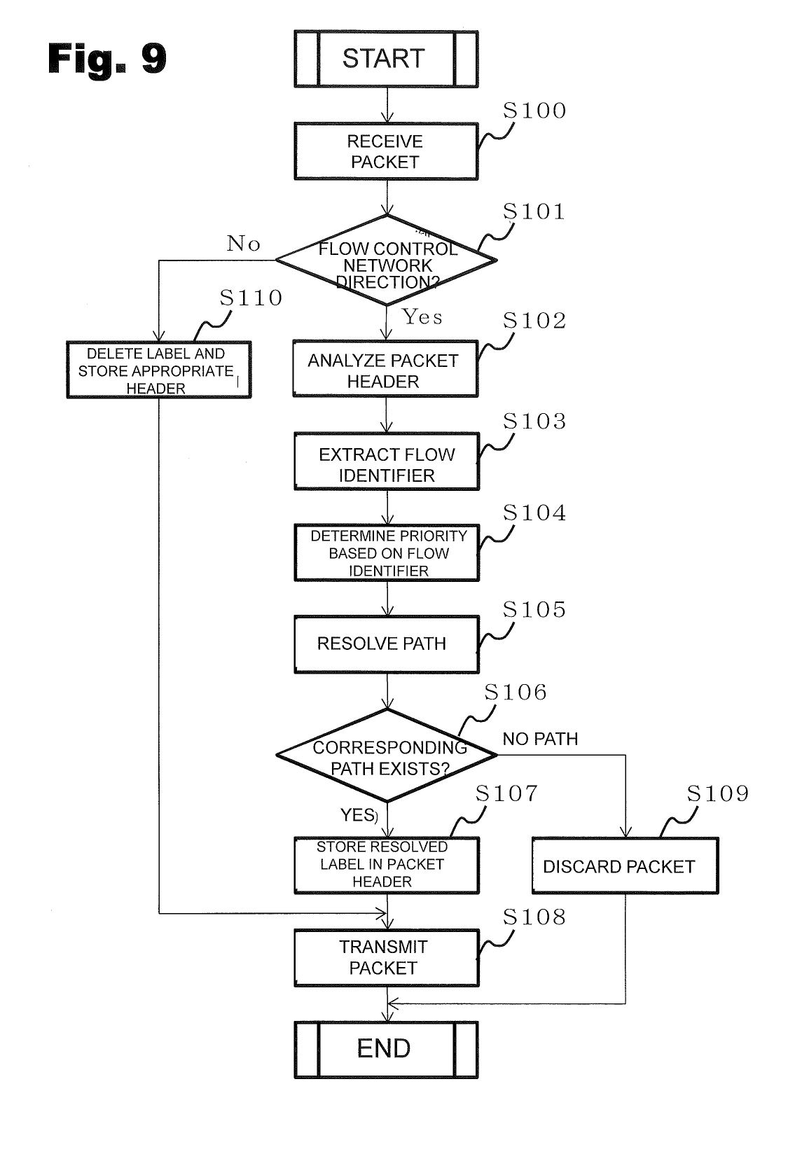

FIG. 9 is a flowchart showing the operation of the edge node 101 having entries set in the path table 205 as described above. With reference to FIG. 9, first, having received a packet from the terminal 100-1 with the reception unit 200 (step S100 in FIG. 9), the edge node 101 determines whether or not the packet is bound for the forwarding network 108 (step S101 in FIG. 9).

The edge node 101 determines whether or not the packet is bound for the forwarding network 108 based on whether the port that has received the received packet is a port connected to the terminal 100-1 or a port connected to the forwarding node 102 on the side of the forwarding network 108. When the received packet is bound for the forwarding network 108, the edge node 101 hands over the received packet to the packet analysis unit 201 and lets it analyze the packer header (step S102 in FIG. 9).

Next, the flow identifying unit 202 extracts a flow identifier as information specifying an application from an upper layer protocol header included in the payload of the packet based on the position of the payload specified by the packer header analysis (step S103 in FIG. 9). The flow identifier corresponds to an URL in the Web service.

Further, the flow identifying unit 202 determines the priority by referring to the priority table 203 (step S104 in FIG. 9). As shown in FIG. 5, the priority table 203 is constituted by the source IP address 300, the flow identifier 301, and the priority 302, and the priority can be determined by performing a search using the source IP address extracted by the packet analysis unit 201 and the flow identifier extracted by the flow identifying unit 202.

Next, the path resolution unit 204 resolves a path, i.e., sub-labels, by referring to the path table 205 (step S105 in FIG. 9). The path table 205 is capable of resolving sub-labels using the destination IP address 400 and the priority 401 as search keys, as shown in FIG. 6. It can also determine whether or not a registered path is available from the path status 402. When no path with the path status 402 indicating “normal” is registered, the edge node 101 discards the received packet (step S109 in FIG. 9).

When an entry corresponding to the destination IP address 400 and the priority 401 of the received packet is registered in the path table 205, the edge node 101 generates a label by linking the sub-labels resolved in the label storage unit 206 and stores the label in the packet header (step S107 in FIG. 9). In the present exemplary embodiment, the source MAC (Media Access Control) address is used as a region that stores a label. Note that any other regions controllable by the forwarding node 102 can be used as the label storage region, in addition to the source MAC address. Needless to say, a configuration in which an additional header for storing a label is added to a packet or a configuration in which a label is stored in an option field of an existing header can be employed.

The transmission unit 207 transmits the packet with the label stored to the forwarding network 108 (step S108 in FIG. 9).

The forwarding node 102-1 receives the packet from the edge node 101-1 in the forwarding network 108. Since the forwarding node 102-1 belongs to the first horizontal level 105, forwarding processing is performed based on the first sub-label 501 in the label stored in the packet header. The forwarding node 102-1 has an entry set to be outputted to the forwarding node 102-5 for the first sub-label 603 of the label stored by the edge node 101-1 in the flow table, and transmits the packet to the forwarding node 102-5 according to this setting.

Similarly, since the forwarding node 102-5 belongs to the second horizontal level 106, forwarding processing is performed based on the second sub-label 502 in the label stored in the packet header. The forwarding node 102-5 has an entry set to be outputted to the forwarding node 102-6 for the second sub-label 604 of the label stored by the edge node 101-1 in the flow table, and transmits the packet to the forwarding node 102-6 according to this setting.

Similarly, since the forwarding node 102-6 belongs to the third horizontal level 107, forwarding processing is performed based on the third sub-label 503 in the label stored in the packet header. The forwarding node 102-6 has an entry set to be outputted to the edge node 101-3 for the third sub-label 605 of the label stored by the edge node 101-1 in the flow table, and transmits the packet to the edge node 101-3 according to this setting.

The edge node 101-3 receives the packet with the reception unit 200 (the step 5100 in FIG. 9) and determines whether or not the packet is bound for the forwarding network 108 (the step S101 in FIG. 9). Since the packet is not bound for the forwarding network 108, the reception unit 200 hands over the packet to the header conversion unit 209. The header conversion unit 209 stores the MAC address of the edge node 101-3 in the source MAC address where the label is stored (step S110 in FIG. 9; restoration processing). The transmission unit 207 transmits the packet storing this MAC address to the server 103-1 (the step 5108 in FIG. 9).

Since packet forwarding in the direction from the server 103-1 to the terminal 100-1 is controlled identically to the description above, the explanation will be omitted.

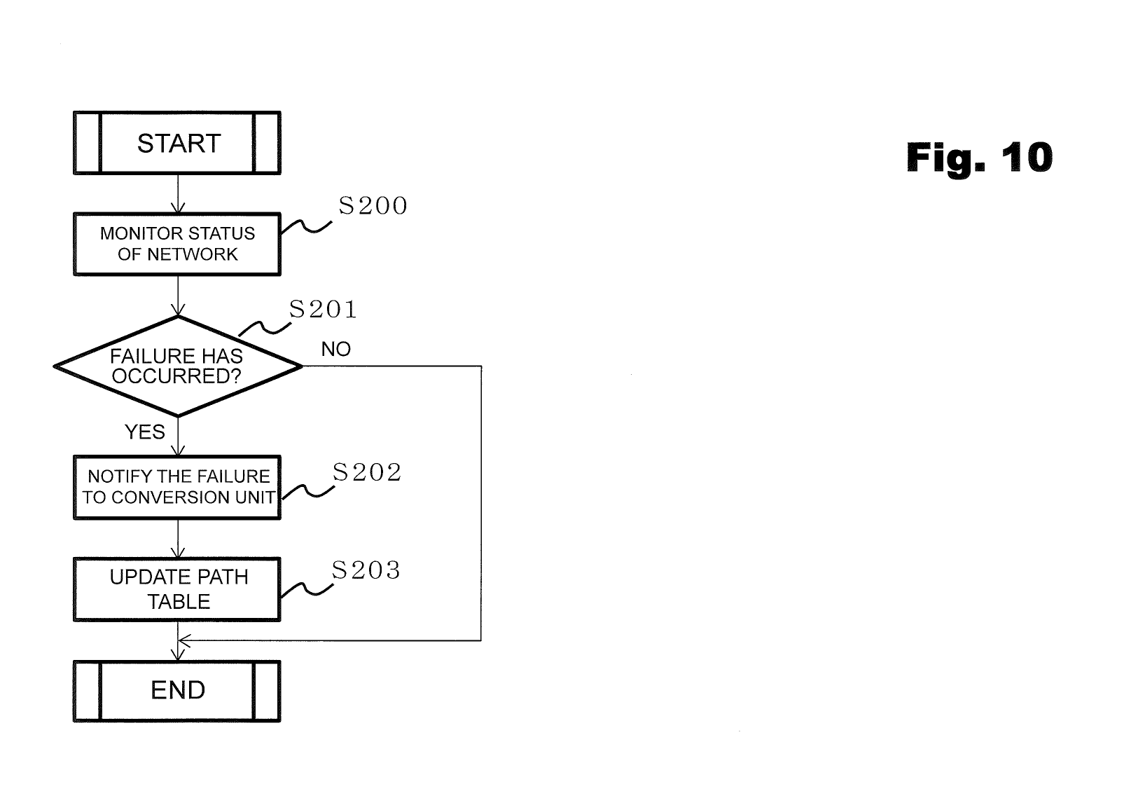

Next, described will be the operation in a case where a failure occurs in the forwarding node 102-5 and the path thereof is not available. FIG. 10 is a flowchart showing the operation of the control apparatus of the first exemplary embodiment of the present disclosure.

The control apparatus 104 monitors any failure in the forwarding nodes 102 or in the paths between the forwarding nodes 102 in the forwarding network 108 (step S200 in FIG. 10).

When detecting a failure in one of the forwarding nodes 102 (step S201 in FIG. 10), the control apparatus 104 notifies the fact that the failure has occurred and which forwarding node has failed to the edge nodes 101-1 to 101-4 (step S202 in FIG. 10). Here, it is assumed that a failure has occurred in the forwarding node 102-5 in FIG. 3.

The path management unit 208 of the edge node 101-1 that has received the notification updates the path table 205 based on the failure information received from the control apparatus 104 (step 5203 in FIG. 10). More concretely, the path management unit 208 changes the path status 402 of the corresponding entry in the path table 205 in FIG. 6 from normal to abnormal regarding the path going through the forwarding node 102-5. By updating the path table 205, packets received by the edge node 101-1 thereafter are processed by an entry for the path going through an alternate route of the forwarding nodes 102-1, 102-4, and 102-6, instead of an entry for the path going through the forwarding nodes 102-1, 102-5, and 102-6.

As described above, the path control system of the present exemplary embodiment including the forwarding network 108 constituted by the forwarding nodes 102-1 to 102-8, the edge nodes 101 that store a label for forwarding a received packet over the forwarding network 108 in the packet header based on the payload information of the received packet, and the control apparatus 104 that controls these devices manages the forwarding network by dividing the network into several levels, and sets sub-labels and a forwarding destination according to the level where each forwarding node belongs. The edge node 101 resolves sub-labels for each level of the forwarding network 108 and stores the sub-labels as a label in the packet header. As a result, path control for each application is achieved when a failure occurs in the forwarding network 108.

Further, a computer program can realize the processing of the edge node and the control apparatus shown in FIGS. 9 and 10 by having a computer built into these devices execute each processing described above using the hardware thereof.

### Second Exemplary Embodiment

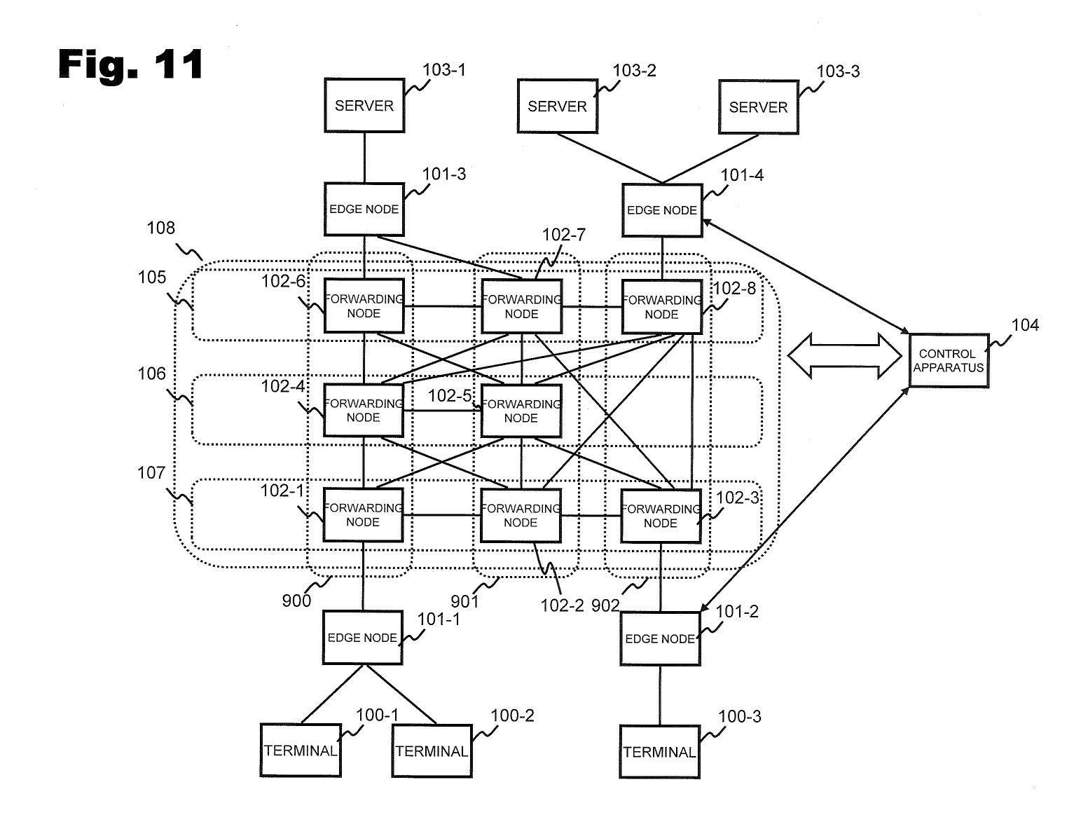

Next, a second exemplary embodiment of the present disclosure in which forwarding nodes belong to a plurality of levels in the form of a matrix will be described in detail with reference to the drawings. FIG. 11 is a drawing illustrating the configuration of a path control system of the second exemplary embodiment of the present disclosure. The second exemplary embodiment differs from the first exemplary embodiment shown in FIG. 3 in that a first vertical level 900, a second vertical level 901, and a third vertical level 902 are newly defined in the forwarding network 108. For instance, the forwarding node 102-1 belongs to the third horizontal level 107 and the first vertical level 900, and the forwarding node 102-3 belongs to the third horizontal level 107 and the third vertical level 902.

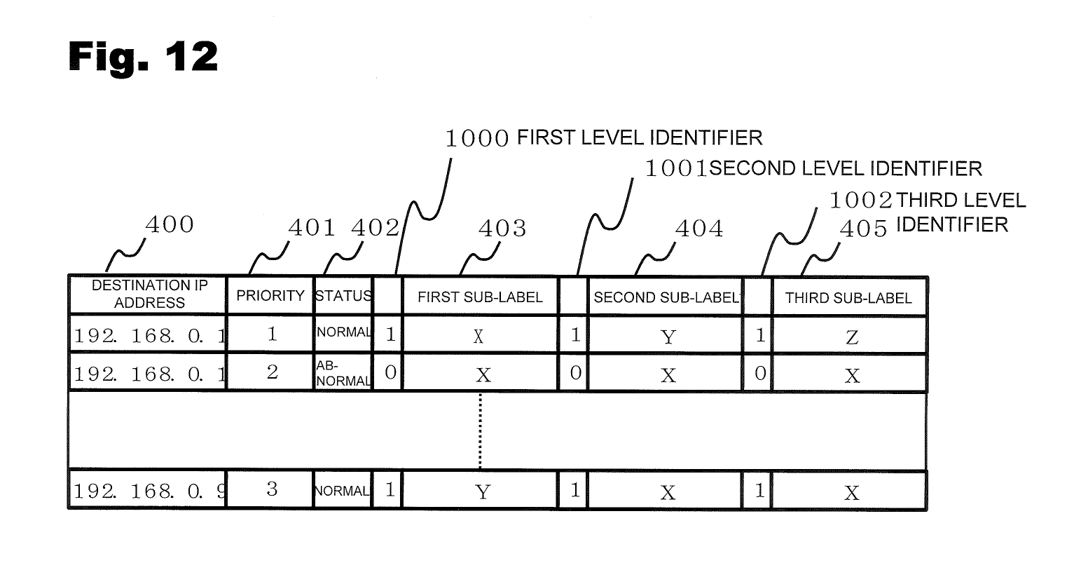

FIG. 12 shows the path table 205 in the present exemplary embodiment, and the difference is that this path table has a first level identifier 1000, a second level identifier 1001, and a third level identifier 1002, in addition to the sub-labels.

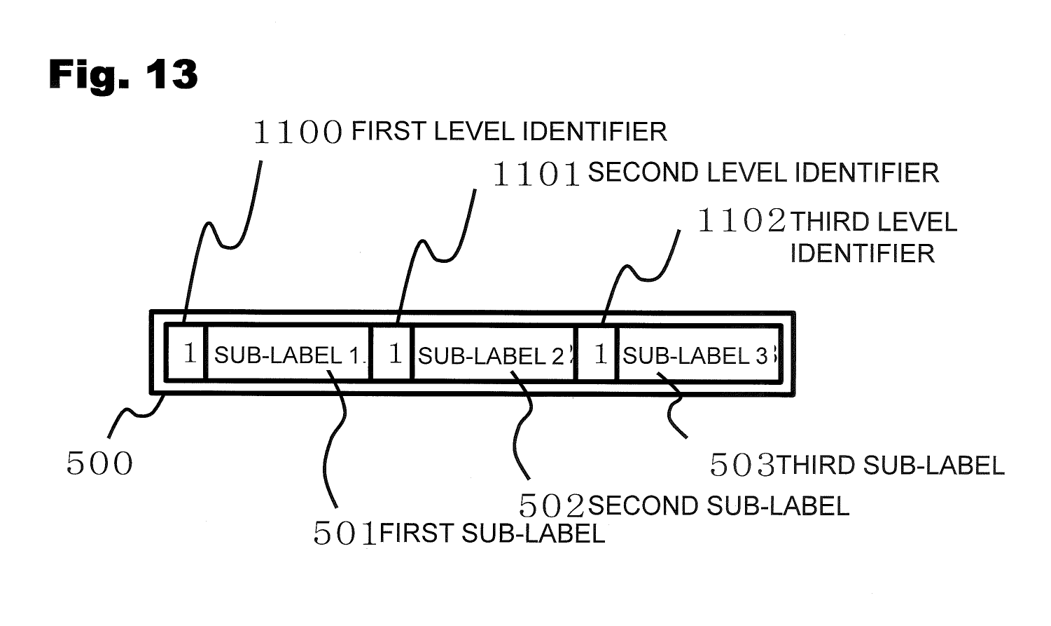

FIG. 13 shows a label that the edge node 101 stores in a packet header, and the difference is that this label has a first level identifier 1100, a second level identifier 1101, and a third level identifier 1102, in addition to the sub-labels.

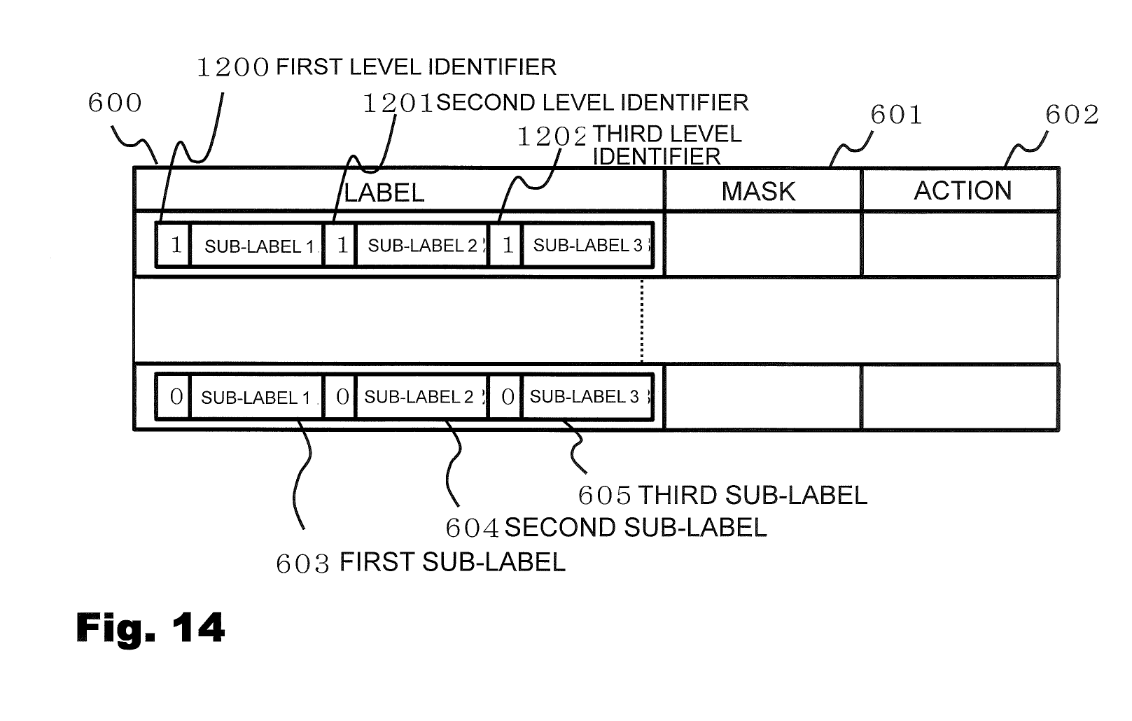

FIG. 14 shows a flow table of the forwarding node 102, and the difference is that a first level identifier 1200, a second level identifier 1201, and a third level identifier 1202 are set as matching conditions in this flow table, in addition to the sub-labels.

The second exemplary embodiment of the present disclosure performs management with the level identifiers added to the sub-labels of the first exemplary embodiment. Since the operation of the present exemplary embodiment can be explained by replacing the path control in the first exemplary embodiment using the sub-labels with path control using the sub-labels and the level identifiers, the explanation will be omitted.

As described above, according to the present exemplary embodiment, it becomes possible to perform detailed control of communication between terminals or between servers by managing the forwarding network 108 while dividing it into several vertical levels.

### Third Exemplary Embodiment

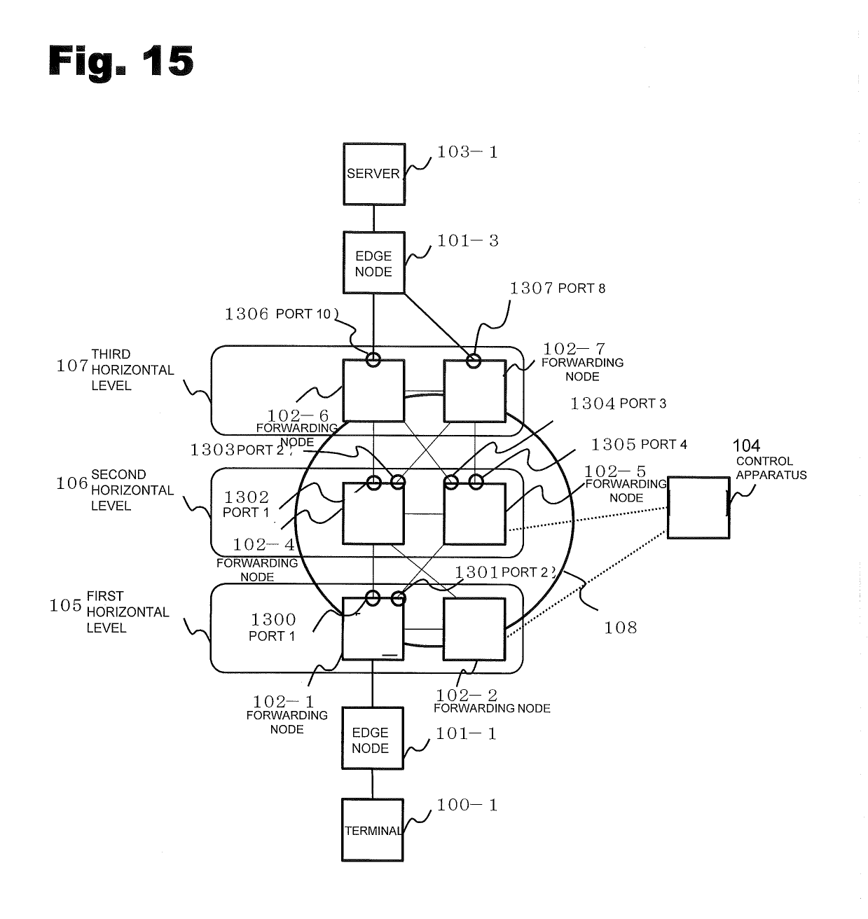

Next, an exemplary embodiment in which the first exemplary embodiment is more specifically embodied will be described as a third exemplary embodiment of the present disclosure. In the present exemplary embodiment, communication between the terminal 100-1 and the server 103-1, shown in FIG. 15, will be described. It is assumed that the terminal 100-1 has an IP address “10.0.0.1” and the server 103-1 has an IP address “192.168.0.1.” Further, according to FIG. 15, the terminal 100-1 is connected to the edge node 101-1 and contained in the forwarding network 108. Similarly, the server 103-1 is connected to the edge node 101-3 and contained in the forwarding network 108.

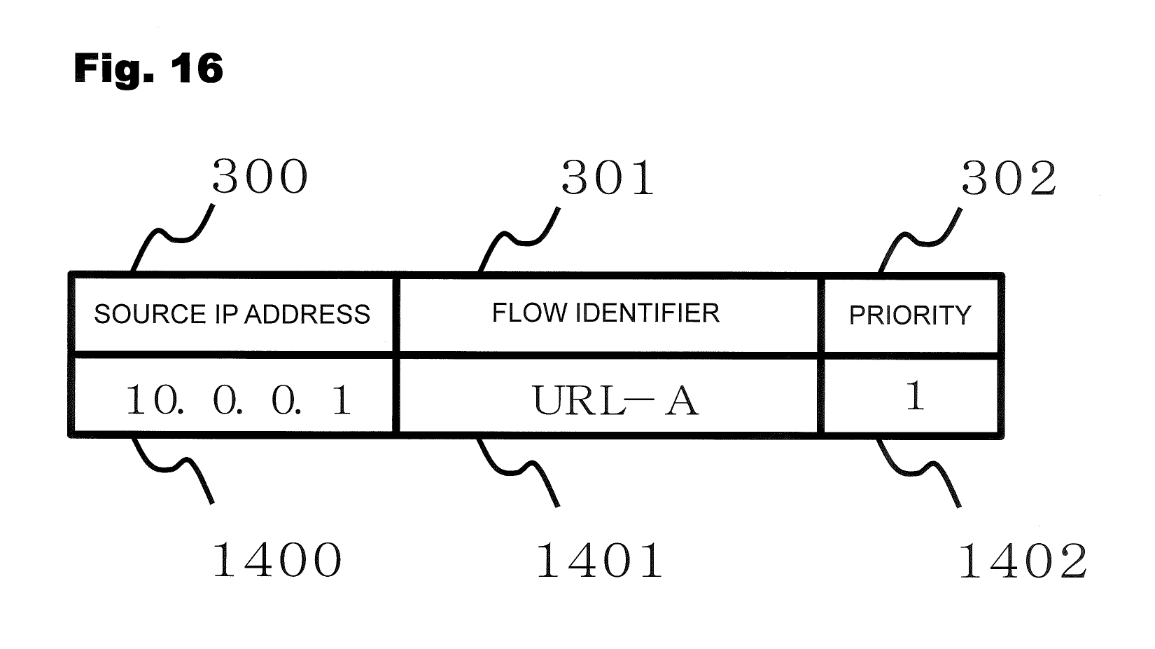

FIG. 16 is a drawing showing the configuration of the priority table 203 in the edge node 101-1. In the priority table 203, an entry having the IP address of the terminal 100-1 “10.0.0.1” as the source IP address 300 (1400 in FIG. 16), URL-A provided by the server 103-1 as the flow identifier (1401 in FIGS. 16), and “1” as the priority (1402 in FIG. 16) associated with each other is set.

The forwarding node 102 is assumed to be a 48-port switch and connected as follows. The forwarding node 102-1 has a port 1 (1300 in FIG. 15) connected to the forwarding node 102-4 and a port 2 (1301 in FIG. 15) connected to the forwarding node 102-5. The forwarding node 102-4 has a port 1 (1302 in FIG. 15) connected to the forwarding node 102-6 and a port 2 (1303 in FIG. 15) connected to the forwarding node 102-7. The forwarding node 102-5 has a port 3 (1304 in FIG. 15) connected to the forwarding node 102-6 and a port 4 (1305 in FIG. 15) connected to the forwarding node 102-7. The forwarding node 102-6 has a port 10 (1306 in FIG. 15) connected to the edge node 101-3. The forwarding node 102-7 has a port 8 (1307 in FIG. 15) connected to the edge node 101-3.

In the forwarding network 108 shown in FIG. 15, as paths between the terminal 100-1 and the server 103-1, four paths exist: a path going through the forwarding nodes 102-1, 102-4, and 102-6, a path going through the forwarding nodes 102-1, 102-4, and 102-7, a path going through the forwarding nodes 102-1, 102-5, and 102-6, and a path going through the forwarding nodes 102-1, 102-5, and 102-7.

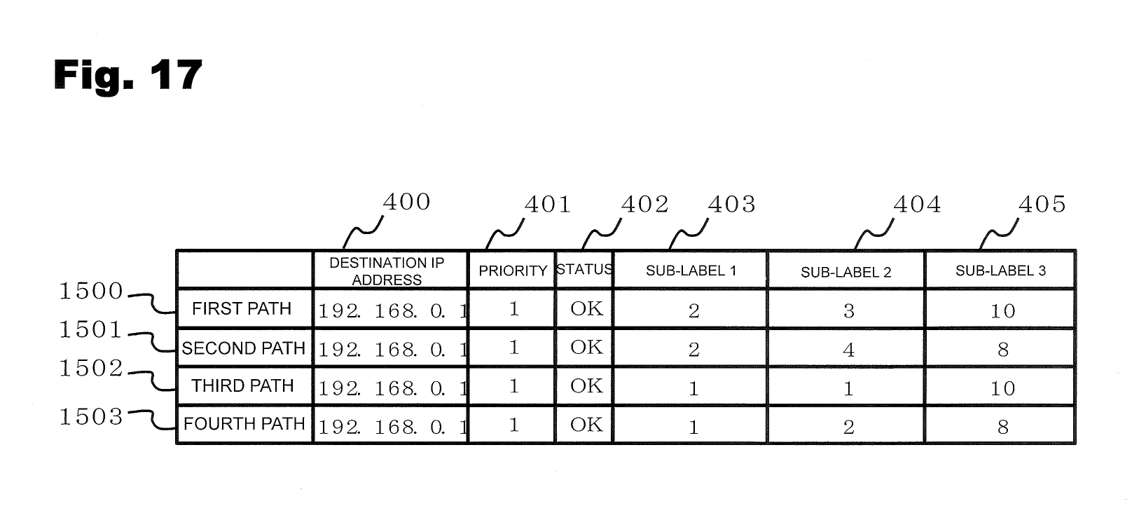

FIG. 17 shows the path table 205 of the edge node 101-1 regarding the paths between the terminal 100-1 and the server 103-1. It is assumed that the following has been set in the path table 205 by the control apparatus 104. All the path entries have “192.168.0.1,” the IP address of the server 103-1, as the destination IP address 400, and “1” as the priority 401. Further, the path status 402 of each path entry shows “normal.”

A first path 1500 indicates the path going through the forwarding nodes 102-1, 102-5, and 102-6, and has “2” as the first sub-label 403, “3” as the second sub-label 404, and “10” as the third sub-label 405. The sub-labels are used for determining the processing of the forwarding node 102, and to configure forwarding processing from a designated port as the processing of the forwarding node 102, the number of actions corresponding to the number of the ports, i.e., 48 different actions are required. In the present exemplary embodiment, the sub-labels are 6-bit information capable of expressing 48 different actions. Processing other than forwarding from a designated port such as processing of a packet header can be supported by increasing the size of the sub-labels. In the present exemplary embodiment, since the forwarding node 102 only performs forwarding processing from a designated port, the sub-labels are 6-bit information. A second path 1501, a third path 1502, and a fourth path 1503 in the path table 205 are configured similarly to the first path 1500.

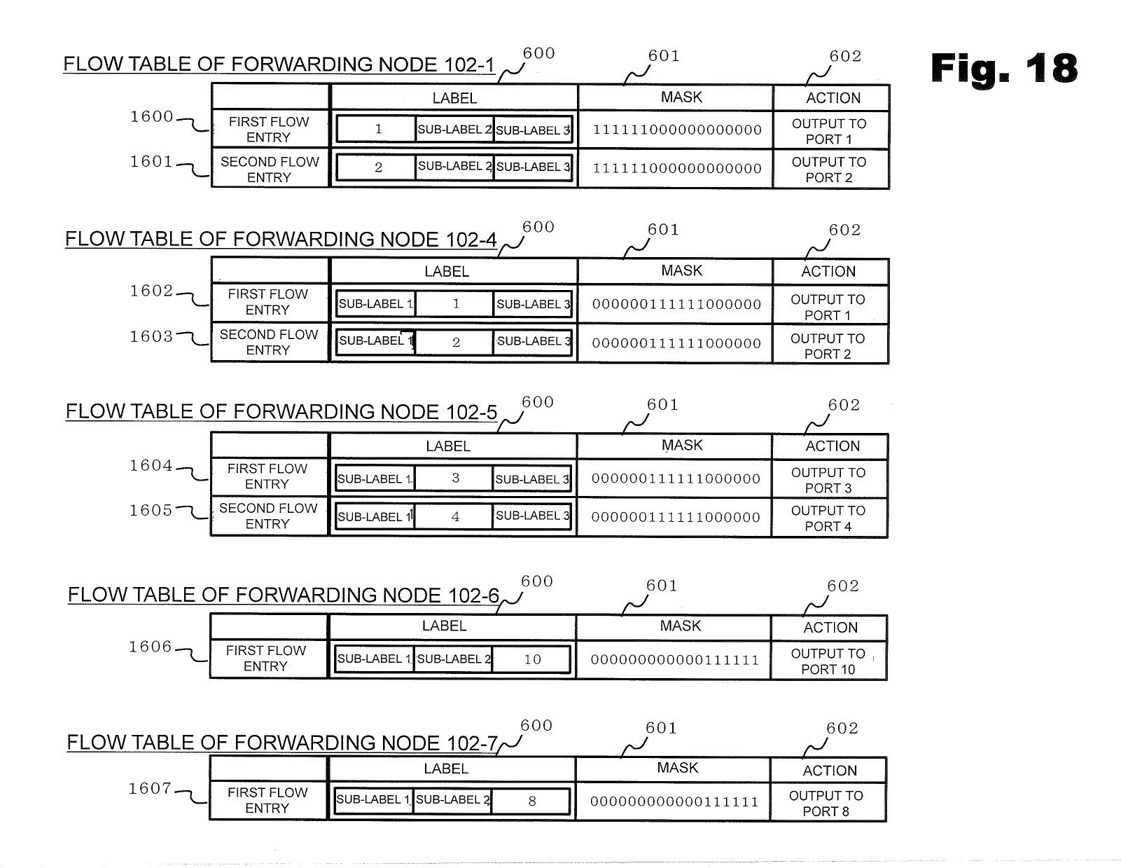

FIG. 18 shows the flow tables of the forwarding nodes 102 in the present exemplary embodiment. The flow tables shown in FIG. 18 are configured by the control apparatus 104 in advance.

In the flow table of the forwarding node 102-1, an entry having a label with “1” set in the first sub-label, “111111000000000000” that indicates reference to the first sub-label as the mask, and “output to the port 1” as the action is stored as a first flow entry 1600. Further, an entry having a label with “2” set in the first sub-label, “111111000000000000” that indicates reference to the first sub-label as the mask, and “output to the port 2” as the action is stored as a second flow entry 1601.

In the flow table of the forwarding node 102-4, an entry having a label with “1” set in the second sub-label, “000000111111000000” that indicates reference to the second sub-label as the mask, and “output to the port 1” as the action is stored as a first flow entry 1602. Further, an entry having a label with “2” set in the second sub-label, “000000111111000000” that indicates reference to the second sub-label as the mask, and “output to the port 2” as the action is stored as a second flow entry 1603.

In the flow table of the forwarding node 102-5, an entry having a label with “3” set in the second sub-label, “000000111111000000” that indicates reference to the second sub-label as the mask, and “output to the port 3” as the action is stored as a first flow entry 1604. Further, an entry having a label with “4” set in the second sub-label, “000000111111000000” that indicates reference to the second sub-label as the mask, and “output to the port 4” as the action is stored as a second flow entry 1605.

In the flow table of the forwarding node 102-6, an entry having a label with “10” set in the third sub-label, “000000000000111111” that indicates reference to the third sub-label as the mask, and “output to the port 10” as the action is stored as a first flow entry 1606.

In the flow table of the forwarding node 102-7, an entry having a label with “8” set in the third sub-label, “000000000000111111” that indicates reference to the third sub-label as the mask, and “output to the port 8” as the action is stored as a first flow entry 1607.

Next, based on the path entries and the flow tables above, packet forwarding from the terminal 100-1 to the server 103-1 will be described in detail with reference to FIG. 9 again.

Having received a packet from the terminal 100-1 with the reception unit 200 (the step S100 in FIG. 9), the edge node 101-1 determines whether or not the packet is bound for the forwarding network 108 (the step S101 in FIG. 9).

Since the packet from the terminal 100-1 to the server 103-1 is bound for the forwarding network 108, the edge node 101 supplies the received packet to the packet analysis unit 201. The packet analysis unit 201 analyzes the packet header and determines the position of the payload (the step S102 in FIG. 9).

The flow identifying unit 202 extracts “URL-A,” information specifying the service to be used and a flow identifier, from the payload of the packet (the step S103 in FIG. 9). Further, the flow identifying unit 202 determines the priority by referring to the priority table 203 (the step S104 in FIG. 9). The priority table 203 is configured as shown in FIG. 16, and the flow identifying unit 202 determines that the priority is “1” based on the IP address of the terminal “10.0.0.1” and the flow identifier “URL-A” extracted from the payload of the packet.

Next, the path resolution unit 204 resolves a path, i.e., sub-labels, by referring to the path table 205 (the step S105 in FIG. 9). The path table 205 is configured as shown in FIG. 17, and a search is performed using the IP address of the server 103-1 “192.168.0.1” and the priority “1” as search keys. As a result of the search, the first path 1500 is obtained, and since the path status 402 is normal, the first sub-label “2,” the second sub-label “3,” and the third sub-label “10” are determined.

The label storage unit 206 generates a label by linking the resolved sub-labels and stores the label in the source MAC address, which is the packet header (the step S107 in FIG. 9). The transmission unit 207 transmits the packet with the label stored to the forwarding network 108 (the step S108 in FIG. 9).

In the forwarding network 108, the forwarding node 102-1 receives the packet from the edge node 101-1. The received packet stores “2” in the first sub-label, matching the second flow entry 1601 in the flow table of the forwarding node 102-1 (refer to FIG. 18). The forwarding node 102-1 refers to the second flow entry 1601 and outputs the packet from the port 2 (1301 in FIG. 15).

Next, the forwarding node 102-5 receives the packet from the forwarding node 102-1. The received packet stores “3” in the second sub-label, matching the first flow entry 1604 in the flow table of the forwarding node 102-5 (refer to FIG. 18). The forwarding node 102-5 refers to the first flow entry 1604 and outputs the packet from the port 3 (1304 in FIG. 15).

Finally, the forwarding node 102-6 receives the packet from the forwarding node 102-5. The received packet stores “10” in the third sub-label, matching the first flow entry 1606 in the flow table of the forwarding node 102-6 (refer to FIG. 18). The forwarding node 102-6 refers to the first flow entry 1606 and outputs the packet from the port 10 (1306 in FIG. 15).

The edge node 101-3 receives the packet with the reception unit 200 (the step S100 in FIG. 9) and determines whether or not the packet is bound for the forwarding network 108 (the step S101 in FIG. 9). Since the packet is not bound for the forwarding network 108, the reception unit 200 hands over the packet to the header conversion unit 209 and the header conversion unit 209 stores the MAC address of the edge node 101-3 in the source MAC address where the label is stored (the step S110 in FIG. 9). The transmission unit 207 transmits the packet to the server 103-1 (the step S108 in FIG. 9).

Since the operation of packet forwarding in the opposite direction from the server 103-1 to the terminal 100-1 is the same as the forwarding from the terminal 100-1 to the server 103-1, the detailed description will be omitted.

Next, the operation in a case where a failure occurs in the forwarding node 102-5 and the path is not available will be described with reference to FIG. 10 again. The control apparatus 104 monitors any failure in the forwarding nodes 102 or in the paths between the forwarding nodes 102 in the forwarding network 108 (the step S200 in FIG. 10).

When detecting a failure in the forwarding node 102-5 (the step S201 in FIG. 10), the control apparatus 104 notifies the failure in the forwarding node 102-5 to the edge nodes 101-1 to 101-4 (the step 5202 in FIG. 10).

The edge node 101-1 that has received the notification receives the failure information received from the control apparatus 104 in the path management unit 208 and updates the path table 205 (the step 5203 in FIG. 10). More concretely, the path management unit 208 changes the path status 402 of the first path 1500 and the second path 1501 in FIG. 17 from normal to abnormal.

By updating the path table 205 as described, the path resolution unit 204 of the edge node 101-1 chooses the third path 1502 for packets received thereafter. Then, the edge node 101-1 stores a label constituted by a first sub-label “1,” a second sub-label “1,” and a third sub-label “10” in a packet header for the flow control network. A packet transmitted by the edge node 101-1 is forwarded using the path going through the forwarding nodes 102-1, 102-4, and 102-6. The details of the forwarding operation will be omitted since it is the same as the normal operation.

The exemplary embodiments of the present disclosure have been described above, however, the present disclosure is not limited to the above exemplary embodiments and further modifications, replacements, and adjustments can be added within the scope of the basic technological concept of the present disclosure. For instance, the network configurations shown in FIGS. 1 to 3, FIG. 11, and FIG. 15 and the configuration of the edge node shown in FIG. 4 are examples to facilitate understanding of the present disclosure and not limited to the configurations shown in these drawings.

Further, for instance, the edge node connected to the server 103 on the downstream side restores the MAC address (rewriting the label added by the edge node on the terminal 101 side back to the MAC address) in the exemplary embodiments above, however, the restoration of the MAC address may be performed by the forwarding node at the last hop.

Finally, preferred modes of the present disclosure will be summarized.

### <Mode 1>

A path control system may be the path control system according to the first aspect.

### <Mode 2>

In the path control system according to Mode 1, the control apparatus may set in advance in the forwarding node control information for forwarding a packet matching the changed sub-label along a path that does not go through the failure section.

### <Mode 3>

In the path control system according to Mode 1 or 2, the control apparatus may cause the forwarding node to perform the forwarding processing based on the sub-labels by specifying a sub-label to be matched against a received packet.

### <Mode 4>

In the path control system according to any one of Modes 1 to 3, the edge node may add sub-labels based on an entry that matches a received packet and that is searched, based on a source address and payload content of the received packet, from a path entry group in which priority information, a destination address, and a combination of sub-labels are associated with each other.

### <Mode 5>

In the path control system according to Mode 4, the path entry may include a field that records a status of a communication path, and the edge node may select an entry having a highest priority and a normal path status from entries matching a received packet.

### <Mode 6>

In the path control system according to any one of Modes 1 to 5, the forwarding node may belong to one of levels set in advance, in addition to the group, and the control apparatus may control forwarding processing that is based on a combination of sub-labels and a level identifier added by the edge node and on the sub-labels and the level identifier in the forwarding node.

### <Mode 7>

In the path control system according to any one of Modes 1 to 6, the edge node may store a generated label in a source MAC address region of a packet header, and the control apparatus may cause an edge node or a forwarding node on a downstream side to perform restoration processing of the source MAC address region.

### <Mode 8>

A control apparatus may be the control apparatus according to the second aspect.

### <Mode 9>

The control apparatus of Mode 8 may set in the edge node, based on a source address and payload content of a packet, a path entry group in which priority information, a destination address, and a combination of sub-labels are associated with each other, and cause the edge node to add sub-labels using an entry that matches a received packet out of path entries in the path entry group.

### <Mode 10>

In the control apparatus according to Mode 9, the path entry may include a field that records a status of a communication path, and the edge node may select an entry having a highest priority and a normal path status from entries matching a received packet.

### <Mode 11>

An edge node may be the edge node according to the third aspect.

### <Mode 12>

A path control method may be the path control method according to the fourth aspect.

### <Mode 13>

A program may be the program according to the fifth aspect.

The entire disclosures of the above Non-Patent Literatures are incorporated herein by reference thereto. Modifications and adjustments of the exemplary embodiment are possible within the scope of the overall disclosure (including the claims) of the present disclosure and based on the basic technical concept of the present disclosure. Various combinations and selections of various disclosed elements (including each element of each claim, each element of each exemplary embodiment, each element of each drawing, etc.) are possible within the scope of the claims of the present disclosure. That is, the present invention of course includes various variations and modifications that could be made by those skilled in the art according to the overall disclosure including the claims and the technical concept. Particularly, any numerical range disclosed herein should be interpreted that any intermediate values or subranges falling within the disclosed range are also concretely disclosed even without specific recital thereof.

### REFERENCE SIGNS LIST

10, 11, 12: terminal
20: edge node
30: forwarding network
30a to 30f: forwarding node
40: control apparatus
100-1 to 100-3: terminal
101-1 to 101-4: edge node
102-1 to 102-8: forwarding node
103-1 to 103-3: server
104: control apparatus
105: first horizontal level
106: second horizontal level
107: third horizontal level
108: forwarding network
200: reception unit
201: packet analysis unit
202: flow identifying unit
203: priority table
204: path resolution unit
205: path table
206: label storage unit
207: transmission unit
208: path management unit
209: header conversion unit
300: source IP address
301: flow identifier
302: priority
400: destination IP address
401: priority
402: path status
403: first sub-label
404: second sub-label
405: third sub-label
500: label
501: first sub-label
502: second sub-label
503: third sub-label
600: label
601: mask
602: action
603: first sub-label
604: second sub-label
605: third sub-label
900: first vertical level
901: second vertical level
902: third vertical level
1000, 1100, 1200: first level identifier
1001, 1101, 1201: second level identifier
1002, 1102, 1202: third level identifier
1300: port 1 of the forwarding node 102-1
1301: port 2 of the forwarding node 102-1
1302: port 1 of the forwarding node 102-4
1303: port 2 of the forwarding node 102-4
1304: port 3 of the forwarding node 102-5
1305: port 4 of the forwarding node 102-5
1306: port 10 of the forwarding node 102-6
1307: port 8 of the forwarding node 102-7
1400: source IP address (10.0.0.1)
1401: flow identifier (URL-A)
1402: priority (1)
1500: first path
1501: second path
1502: third path
1503: fourth path
1600: first flow entry in the forwarding node 102-1
1601: second flow entry in the forwarding node 102-1
1602: first flow entry in the forwarding node 102-4
1603: second flow entry in the forwarding node 102-4
1604: first flow entry in the forwarding node 102-5
1605: second flow entry in the forwarding node 102-5
1606: first flow entry in the forwarding node 102-6
1607: first flow entry in the forwarding node 102-7

What is claimed is:

1. A path control system, comprising:
a forwarding network in which each forwarding node belongs to a group and forwards a packet based on a sub-label corresponding to the group;
at least one edge node that adds a label including a plurality of sub-labels based on information contained in a received packet; and
a control apparatus that performs path control of the forwarding network by controlling a combination of sub-labels added by the edge node and by controlling forwarding processing performed based on the sub-labels by the forwarding node(s), wherein
when a failure has occurred in a communication path, the control apparatus causes the edge node to change a sub-label corresponding to a failure section of the communication path in which a failure has occurred out of sub-labels added to a packet received after the failure, and causes the forwarding node(s) to forward a packet along a path that does not go through the failure section.

2. The path control system according to claim 1, wherein
the control apparatus sets in advance in the forwarding node control information for forwarding a packet matching the changed sub-label along a path that does not go through the failure section.

3. The path control system according to claim 1, wherein
the edge node adds sub-labels based on an entry that matches a received packet and that is selected, based on a source address and payload content of the received packet, from a path entry group in which priority information, a destination address, and a combination of sub-labels are associated with each other.

4. The path control system according to claim 3, wherein the path entry includes a field that records a status of a communication path, and
the edge node selects an entry having a highest priority and a normal path status from entries matching a received packet.

5. The path control system according to claims 1, wherein
the forwarding node belongs to one of levels set in advance, in addition to the group, and
the control apparatus controls forwarding processing that is based on a combination of sub-labels and a level identifier added by the edge node and on the sub-labels and the level identifier in the forwarding node.

6. The path control system according to claims 1, wherein
the edge node stores a generated label in a source MAC address region of a packet header, and
the control apparatus causes an edge node or a forwarding node on a downstream side to perform restoration processing of the source MAC address region.

7. A control apparatus, connected to a forwarding network in which each forwarding node belongs to a group and forwards a packet based on a sub-label corresponding to the group and to at least one edge node that adds a label including a plurality of sub-labels based on information contained in a received packet, performing path control of the forwarding network by controlling a combination of sub-labels added by the edge node and by controlling forwarding processing performed based on the sub-labels by the forwarding node(s), wherein
when a failure has occurred in a communication path, the control apparatus causes the edge node to change a sub-label corresponding to a failure section of the communication path in which the failure has occurred out of sub-labels added to a packet received after the failure, and causes the forwarding node(s) to forward a packet along a path that does not go through the failure section.

8. The control apparatus according to claim 7, setting in the edge node, based on a source address and payload content of a packet, a path entry group in which priority information, a destination address, and a combination of sub-labels are associated with each other, and causing the edge node to add sub-labels using an entry that matches a received packet out of path entries in the path entry group.

9. The control apparatus according to claim 8, wherein
the path entry includes a field that records a status of a communication path, and
the edge node selects an entry having a highest priority and a normal path status from entries matching a received packet.

10. A path control method, in a path control system that comprises a forwarding network in which each forwarding node belongs to a group and forwards a packet based on a sub-label corresponding to the group, at least one edge node that adds a label including a plurality of sub-labels based on information contained in a received packet, and a control apparatus that performs path control of the forwarding network by controlling a combination of sub-labels added by the edge node and controlling forwarding processing performed based on the sub-labels by the forwarding node(s), the path control method comprising:
detecting whether or not a failure has occurred in the communication path;
when a failure has occurred in the communication path, causing the edge node to change a sub-label corresponding to a failure section of the communication path in which the failure has occurred out of sub-labels added to a packet received after the failure; and
causing the forwarding node(s) to forward a packet along a path that does not go through the failure section.

11. The control apparatus according to claim 7, wherein the control apparatus sets in advance in the forwarding node control information for forwarding a packet matching the changed sub-label along a path that does not go through the failure section.

12. The control apparatus according to claim 7, wherein
the forwarding node belongs to one of levels set in advance, in addition to the group, and
the control apparatus controls forwarding processing that is based on a combination of sub-labels and a level identifier added by the edge node and on the sub-labels and the level identifier in the forwarding node.

13. The control apparatus according to claim 7, wherein
the edge node stores a generated label in a source MAC address region of a packet header, and
the control apparatus causes an edge node or a forwarding node on a downstream side to perform restoration processing of the source MAC address region.

14. The path control method according to claim 10, comprising:
by the control apparatus, setting in advance in the forwarding node control information for forwarding a packet matching the changed sub-label along a path that does not go through the failure section.

15. The path control method according to claim 10, comprising:
by the edge node, adding sub-labels based on an entry that matches a received packet and that is selected, based on a source address and payload content of the received packet, from a path entry group in which priority information, a destination address, and a combination of sub-labels are associated with each other.

16. The path control method according to claim 10, wherein
the path entry includes a field that records a status of a communication path, and
the edge node selects an entry having a highest priority and a normal path status from entries matching a received packet.

17. The path control method according to claim 10, wherein
the forwarding node belongs to one of levels set in advance, in addition to the group, and
the control apparatus controls forwarding processing that is based on a combination of sub-labels and a level identifier added by the edge node and on the sub-labels and the level identifier in the forwarding node.

18. The path control method according to claim 10, comprising:
by the edge node, storing a generated label in a source MAC address region of a packet header; and
by the control apparatus, causing an edge node or a forwarding node on a downstream side to perform restoration processing of the source MAC address region.
